(19) United States
(12) Patent Application Publication
(10) Pub. No.: US 2008/0295254 A1
(43) Pub. Date: Dec. 4, 2008

(54) DEMOLITION TOOL BAR

(76) Inventor: JAMES MEEKINS, Redding, CA (US)

Correspondence Address: STEVEN W. WEBB, 825 College Blvd., Suite 102620, Oceanside, CA, 92057, US

(21) Appl. No.: 12/131,116

(22) Filed: Jun. 1, 2008

Related U.S. Application Data
(60) Provisional application No. 60/941,904, filed on Jun. 4, 2007.

(51) Int. Cl. B66F 15/00

(52) U.S. Cl. 7/166

(57) ABSTRACT

An improved construction pry bar is presented that possesses unique features. The pry bar has a cutting slot in its leading edge that can slice through or grip and remove nails from construction materials. The pry bar head also possesses two flat shoulders that make it possible to drive the pry bar between two pieces of construction material by means of foot pressure or the use of a hammer.

### RELATED APPLICATIONS

This application claims the benefit of Provisional Patent Application 60/941,904, filed Jun. 4, 2007.

### FIELD OF THE INVENTION

This invention is an improved demolition tool, or crowbar. These tools are of a type that used to separate one layer or layers of material from a base by a wedging and cutting action.

### BACKGROUND OF THE INVENTION

When demolishing wooden structures, for example roofing, it is necessary to be able the separate wooden components nailed together with standard construction nails. The usual tools previously employed is a long-handled pry bar or demolition bar. Because of the rounded heel of the pry bar head, it is sometimes difficult to hammer the heel of the pry bar head between two pieces of wood nailed closely together. Often, other tools must be employed, such as chisels or wedges, or a shovel, to open access for a demolition pry bar.

Pry bars in general are not designed to be hammered between boards, and can be damaged by misuse in this way. It is inconvenient to have to resort to other tools to wedge or pry an access point for the demolition tool.

U.S. Pat. No. 4,183,503 to Ward reveals an improved demolition tool with a traditional curved crowbar head and a pivot bar at the end close to the head. U.S. Pat. No. 6,098,292 to Harpell teaches a roofing tool that is designed to lift roofing shingles or tiles off of a substrate. U.S. Pat. No. 6,302,375 to Heil et al. shows a prying tool with a pivot bar near its head to be used for lifting floorboards and the like. None of these devices possesses the features of hammerability and nail cutting that the present invention possesses.

### SUMMARY OF THE INVENTION

The present invention provides an improved tool of a type adapted to be driven between layers of material and a lever base to separate the layers of material. The tool head has impact receiving means allowing it to be hammered, if required, during use to aid in separating and cutting the material layers.

It is another purpose of the present invention to provide an improved tool that more easily separates layers of material from a base by wedging the layers from each other.

It is a further purpose of the present invention to provide a tool for separating layers of material each other that can remove any headed fastening means holding the layers together. The improved tools are particularly useful for demolishing wooden frame buildings

### BRIEF DESCRIPTION OF THE DRAWINGS

FIG. 1. Perspective view of the invention

FIG. 2. Close-up view of the head of the invention

### DETAILED SPECIFICATION

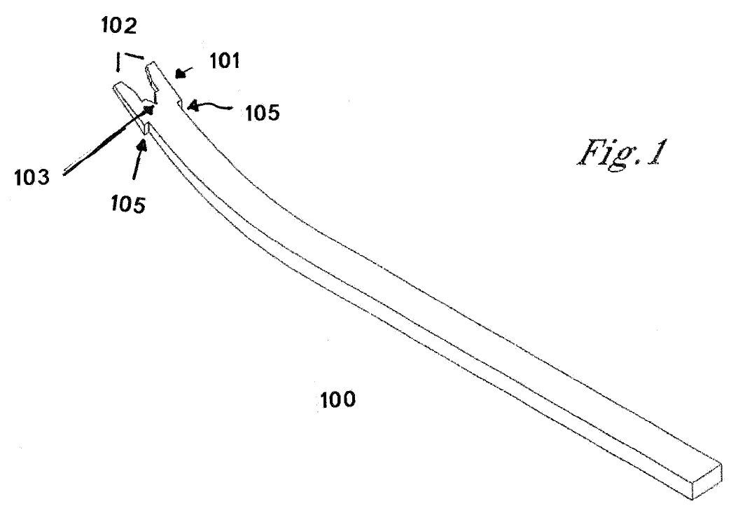

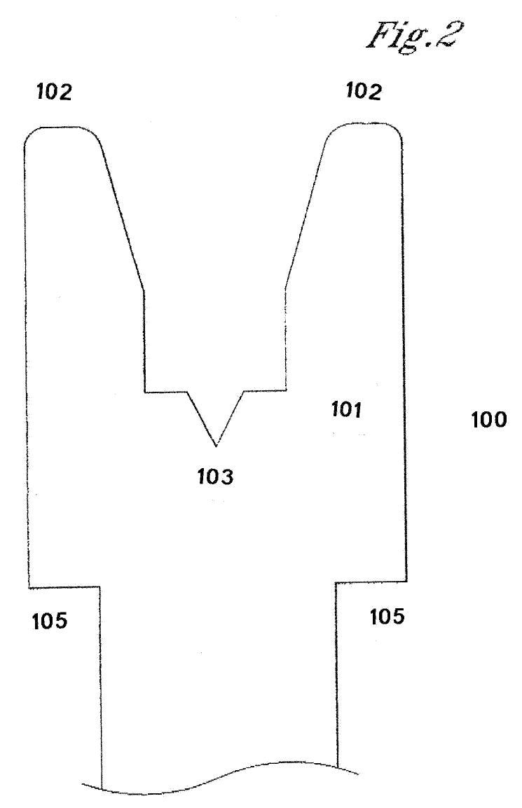

As shown in FIG. 1 and FIG. 2, the invention 100 is a tool having a curved blade 101 with a beveled leading edge 102, bifurcated into a gripping and cutting slot 103. The head of the tool possesses a hammer receiving means 105 on each side of the prying bar handle 104 which can be hammered to drive the beveled leading edge 102 of the blade in between layers of material to prepare the material to be pried apart.

This hammer receiving means 105 can also be used to push the cutting slot 103 by means of foot pressure to cut the layers of material, if required. The hammer receiving means 105 is a thickened, flat rear edge of the blade in the preferred embodiment.

The cutting slot 103 is sized and shaped to allow the invention 100 to easily lift nails or screws remaining as the layers of material are separated and removed. The triangular shape of the cutting slot 103 is sharpened such that it can be hammered on the hammer receiving means 105 with sufficient force to cut a steel nail.

While the foregoing describes a preferred embodiment, variation on this design and equivalent methods may be resorted to in the scope and spirit of the claimed invention.

What is claimed is:

1. a pry bar, comprised of a curved blade and a lever handle, the pry bar comprised of steel that is cast or forged,
the curved blade possessing a beveled leading edge, the beveled leading edge bifurcated into a gripping and cutting slot,
the curved blade constructed to merge smoothly into the lever handle, the end of the curved blade away from the beveled leading edge configured into a hammer receiving means, the hammer receiving means a flat shoulder on each side of the curved blade where it merges into the lever handle,
the gripping and cutting slot a triangular cut in the beveled leading edge, the apex of the triangular slot sharpened and large enough to grip a construction nail.

2. A method of using a pry bar as in claim 1, comprised of the steps of
grasping the pry bar by the lever handle,
sliding the beveled leading edge of the curved blade between two pieces of material,
using foot pressure on the hammer receiving means, press the beveled leading edge of the curved blade completely between the pieces of material,
using downward pressure on the lever handle, separate the pieces of material from each other.

3. A method of using a pry bar as in claim 1, comprised of the steps of
grasping the pry bar by the lever handle,
sliding the beveled leading edge of the curved blade between two pieces of material,
using a hammer to strike the hammer receiving means, press the beveled leading edge of the curved blade completely between the pieces of material,
using downward pressure on the lever handle, separate the pieces of material from each other.

4. A method of using a pry bar as in claim 1, comprised of the steps of
grasping the pry bar by the lever handle,
sliding the beveled leading edge of the curved blade such that the gripping and cutting slot encounters a nail or screw,
using foot pressure on the hammer receiving means, pressing the apex of the gripping and cutting slot such that it grasps the nail or screw,
using downward pressure on the lever handle, pulling the nail or screw out of the material it is placed in.
